(19) United States
(12) Patent Application Publication
(10) Pub. No.: US 2015/0093659 A1
(43) Pub. Date: Apr. 2, 2015

(54) ALUMINIUM-AIR BATTERY AND ACCUMULATOR SYSTEM

(71) Applicant: IFP Energies nouvelles, Rueil-Malmaison (FR)

(72) Inventors: Serge Gonzalez, Jonage (FR); Renaud Revel, Serpaize (FR)

(21) Appl. No.: 14/398,481

(22) PCT Filed: Sep. 4, 2013
(86) PCT No.: PCT/FR2013/050766

§ 371 Date: Nov. 3, 2014

(30) Foreign Application Priority Data
May 4, 2012 (FR) 12/01.303

(51) Int. Cl. H01M 12/08; H01M 4/90; H01M 8/02; H01M 4/86

(52) U.S. Cl. CPC H01M 12/08; H01M 4/8605; H01M 4/9016; H01M 8/02; H01M 2300/0025; H01M 2300/0085; H01M 2250/20
USPC 429/405; 429/403

(57) ABSTRACT

The invention relates to an electrochemical cell capable of generating and/or accumulating electrical energy, comprising an oxidizable electrode (2) made of aluminium or aluminium alloy, a conductive air electrode (1) allowing the diffusion of air and reduction of the oxygen in air, and an electrolyte (3). Electrolyte (3) is non-aqueous and it comprises a mixture of aluminium trichloride (AlCl₃) with a chlorinated cyclic or heterocyclic, aliphatic nitrogen derivative.

The invention also relates to an electrochemical system for storing electrical energy comprising at least one such cell.

### FIELD OF THE INVENTION

The present invention relates to the sphere of electrical energy storage, and notably to metal-air electrochemical cells.

Electrical energy storage means, notably batteries, are more and more frequently used, for increasingly varied applications: mobile phones, laptops, portable tools, electric or hybrid vehicles, etc. For such applications, the energy storage means need to be light, compact, and they must meet the electrical requirements linked with their use.

### BACKGROUND OF THE INVENTION

Among the accumulator systems considered for the motor vehicles of the future, metal-air batteries appear to be the most promising options in terms of theoretical energy density. A metal-air electrochemical cell consists of a negative electrode (anode) where the metal is the seat of an oxidation reaction during cell discharge, while the positive electrode (cathode, also referred to as air electrode) involves a reduction reaction of the oxygen in air, and an electrolyte provides ionic conduction between electrodes by means of ionic species. The air electrode most often consists of an assembly of two active layers containing a catalyst with a metal grid sandwiched between them.

Selection of the metal used is an important stage in the design of the electrochemical cell. Lithium (Li) is the most electronegative element and the lightest metal, therefore significant development work is naturally being done on Li-air batteries, as shown for example in patent application US-2009/0,053,594 A1. However, lithium is a material that can present a certain number of hazards when exposed to ambient air and, although the natural reserves of this metal are large, the extraction and treatment costs are also high. Besides, massive use of lithium in Li-ion batteries tends to decrease these reserves. There is also an increasing interest in silicon and patent application WO-2011/061,728 A1 describes such a system. In this document, the silicon used is doped n or p-type silicon, which represents a relatively high extra cost, even though the implementation technologies are perfectly controlled for microelectronics.

As for aluminium, it is a trivalent metal of low atomic mass, abundant, which presents no hazards when exposed to air and is relatively inexpensive. Mechanically rechargeable aluminium-air battery systems are described in the prior art, notably in patent applications WO-2010/132,357 and WO-2002/086,984. The aluminium-air systems described in the prior art involve an electrolyte comprising a saline solution or an alkaline solution. In the latter case, which has been most studied, the reduction reaction of oxygen in water at the cathode generates hydroxyl ions. Oxidation of the metal in the presence of these ions generates the formation of crystalline hydrated aluminium hydroxide that precipitates and progressively clogs the pores of the air cathode, which causes degradation of the electrochemical cell performances.

The first document (WO-2010/132,357) mentions the possibility for the metal electrode to be made of aluminium and describes various types of electrolyte that can be used, but it provides no solution for the problems encountered with aluminium-air systems.

In order to overcome the aforementioned drawback, patent application WO-2002/086,984 describes the use of a “dehydrating” additive for preventing the formation of crystalline hydrated aluminium hydroxide so as to obtain a crystallizing compound with less associated water molecules, which consequently increases the duration of use of the battery. Furthermore, using an additive increases the cost of the cell. However, the conductivity of the electrolyte is decreased when using additives. Indeed, among the organic additives claimed in this document, starch and polyacrylamide increase the viscosity of the medium (formation of a gel) and thus reduce the conductivity. The other two additives decrease the proportion of water present in the electrolyte accordingly, thus making it less conductive.

A second problem linked with aluminium-air batteries is the aluminium corrosion phenomenon observed in alkaline media, which translates into hydrogen release, with the safety problems related thereto, and significant overvoltage that penalizes the global performance of the battery. None of the aforementioned two documents solves this problem; for example, using an additive does not allow the hydrogen release linked with aluminium corrosion to be reduced.

In order to overcome the aforementioned drawbacks, the invention relates to an aluminium-air electrochemical cell comprising an electrolyte that is non-aqueous and, by its composition, barely corrosive to aluminium. Thus, an aluminium-air electrochemical cell equipped with such an electrolyte is light, with good electrochemical performances while having suitable electrical characteristics for electrical energy storage.

### SUMMARY OF THE INVENTION

The invention relates to an aluminium-air electrochemical cell capable of generating and/or accumulating electrical energy, comprising an oxidizable electrode made of aluminium or aluminium alloy, a conductive air electrode allowing the diffusion of air and reduction of the oxygen in air, and an electrolyte. The electrolyte is non-aqueous and it comprises a mixture of aluminium trichloride (AlCl₃) with a chlorinated cyclic or heterocyclic, aliphatic nitrogen derivative.

According to the invention, within the electrolyte, the molar ratio of the proportion of aluminium trichloride (AlCl₃) to the proportion of chlorinated cyclic or heterocyclic, aliphatic nitrogen derivative ranges between 1.01 and 2.

Preferably, the chlorinated cyclic or heterocyclic, aliphatic nitrogen derivative of the electrolyte is selected from among 1-ethyl-3-methyl-imidazolium chloride (EMImCl), 1-butyl-3-methyl-imidazolium chloride, 1-butyl-pyridinium chloride or benzyltrimethylammonium chloride.

Advantageously, the molar ratio of the proportion of aluminium trichloride to the proportion of 1-ethyl-3-methyl-imidazolium chloride (EMImCl) is substantially equal to 1.5.

According to an embodiment of the invention, said electrolyte also comprises an organic liquid and/or an ionic liquid.

Besides, said electrolyte is liquid at the ambient operating temperature of the cell. Alternatively, said electrolyte is a gel at the ambient operating temperature of the cell.

According to an embodiment, said air electrode comprises a microporous multilayer assembly and an active element allowing oxygen reduction.

Advantageously, said air electrode consists of porous carbon, of an oxygen reduction catalyst, of a perfluorinated polymer and of a current collector.

Advantageously, said oxygen reduction catalyst is selected from among the metal oxides, notably manganese, nickel or cobalt oxides, or among the doped metal oxides, or among the noble metals.

The cell can also comprise porous devices upstream from the air electrode.

The invention furthermore relates to an electrochemical system for storing electrical energy comprising at least one cell according to the invention.

In a variant, the electrochemical system for storing electrical energy comprises a plurality of cells as described above, arranged in series and/or in parallel.

Moreover, the invention relates to a vehicle, notably a motor vehicle, comprising at least one electric machine. The vehicle is equipped with an electrical energy storage system according to the invention for supplying said electric machine.

### BRIEF DESCRIPTION OF THE FIGURES

Other features and advantages of the invention will be clear from reading the description hereafter of embodiments given by way of non-limitative example, with reference to the accompanying figures wherein:

FIG. 1 illustrates an aluminium-air electrochemical cell according to the invention, used experimentally,

FIG. 2 illustrates discharge curves of an electrochemical cell according to the invention, and

FIG. 3 illustrates charge and discharge curves of an electrochemical cell according to the invention.

### DETAILED DESCRIPTION

The invention thus relates to an electrolyte for a metal-air electrochemical cell capable of generating and/or accumulating electrical energy. According to a first aspect of the invention, this electrolyte is non-aqueous, which allows to prevent the formation of crystalline hydrated aluminium hydroxide likely to clog the pores of the air electrode of the electrochemical cell. Thus, the performances undergo less degradation over time than with the cells considered in the prior art.

According to a second aspect of the invention, the electrolyte comprises a mixture of a chlorinated cyclic or heterocyclic, aliphatic nitrogen derivative with aluminium trichloride (AlCl₃). This mixture is barely corrosive to aluminium, as has been experimentally verified (the corrosion measurements are described in Example 1). The electrolyte according to the invention can therefore be used in an aluminium-air electrochemical cell while avoiding, on the one hand, the formation of aluminium hydroxide and reducing, on the other hand, the corrosion of the metal electrode, which thus allows hydrogen release to be reduced.

For example, the chlorinated cyclic or heterocyclic, aliphatic nitrogen derivative that is mixed in the electrolyte with aluminium trichloride (AlCl₃) can be selected from among 1-ethyl-3-methyl-imidazolium chloride, 1-butyl-3-methyl-imidazolium chloride, 1-butyl-pyridinium chloride or benzyltrimethylammonium chloride. Other compounds that can be used are described in “Electrodeposition from ionic liquids” edited by F. Endres, D. MacFarlane and A. Abbott, Wiley-VCH (2008). More generally, any mixture of an ionic salt with AlCl₃ allowing to obtain an ionic conductive liquid electrolyte with a sufficient electrochemical window for this reaction to occur can be used.

At ambient temperature, the non-aqueous electrolyte is a liquid or a gel. Potentially flammable in case of a short-circuit, the cylindrical or prismatic batteries comprising a liquid electrolyte based on alkyl carbonates, commonly marketed for portable electronics, do not involve acceptable safety conditions for hybrid electric vehicle or electric vehicle applications because this type of electrolyte is flammable. In order to improve the cell safety, gels are suitably used as electrolytes. When the electrolyte comes in form of a gel, the electrolyte can also contain an ionic solution whose purpose is to provide gel stability at high temperature (around 60° C.).

Advantageously, the molar ratio of aluminium trichloride AlCl₃ to chlorinated nitrogen-containing derivative ranges between 1.01 and 2, with very low corrosion to aluminium. In fact, this ratio provides a high aluminium ion concentration, which promotes diffusion of the ionic species (high transport number) with high current densities and allows a high specific power to be obtained. The electrolyte can also contain ionic and/or organic liquids.

This type of electrolyte causes very little corrosion to aluminium under standard electrochemical cell operating conditions (see Example 1).

The electrolyte according to the invention allows to build an aluminium-air electrochemical cell where the hydrogen release is reduced (because the corrosion phenomenon is limited) and where no aluminium hydroxide forms. This electrochemical system consists of an assembly comprising a metal component (metal electrode) likely to undergo an oxidation reaction, consisting of aluminium or aluminium alloy, of a non-aqueous electrolyte causing very little corrosion to the metal or the alloy, and of an electrode (referred to as air electrode) allowing oxygen reduction.

The air electrode can comprise a microporous multilayer assembly allowing diffusion of the gases and it can comprise at least one active element allowing oxygen reduction. Conventionally, air electrodes are made of porous carbon, perfluorinated polymer such as PTFE, PFA, FEP, etc., and they contain an oxygen reduction catalyst and a current collector. The oxygen reduction catalyst is selected from among the metal oxides, such as manganese, nickel or cobalt oxides for example, the doped metal oxides, or the noble metals such as platinum, palladium or silver.

The electrochemical cell operates indiscriminately with pure oxygen, a mixture of oxygen and nitrogen, or air. It is also possible to add to the cell porous devices arranged upstream from the air electrode and intended to remove the water and/or the carbon dioxide in air.

The geometry of the assembly is not an impediment to the operation of the electrochemical cell if a sufficient oxygen flow rate is maintained to provide smooth operation of the assembly. Any type of cell geometry is thus suited for the invention: the cell can be cylindrical (concentric electrodes), parallelepipedic (parallel electrodes), etc. it is also possible to use an inert porous separator (for example made of woven or non-woven polypropylene, microporous, PTFE, etc.) that provides electrical insulation between the two electrodes.

The electrochemical cell according to the invention comprises a single electrolyte suited to the two electrodes (notably non-corrosive to aluminium) and having good electrochemical characteristics.

A cell consists of an electrochemical system for storing electrical energy, in form of a battery for example.

By associating in series and/or in parallel several cells according to the invention, an electrochemical system for storing electrical energy is constructed, notably a rechargeable battery or an accumulator system (see Example 3). The series and/or parallel connection depends on the desired electrical characteristics (voltage, current, power) for the application of the energy storage system. This electrochemical energy storage system can be used as a battery on board vehicles, electric or hybrid motor vehicles or two-wheelers for example. However, this system is also suitable for use as a battery on board mobile phones, laptops, portable tools, etc.

### APPLICATION EXAMPLES

The applicant has carried out three experimental surveys in order to show the non-corrosivity of the electrolyte to aluminium and the performances of an aluminium-air electrochemical cell according to the invention.

### Example 1

In order to establish the non-corrosivity of the electrolyte to the metal component of the electrochemical cell, the applicant has carried out an experiment to measure the corrosion of aluminium by the electrolyte according to the invention.

1-ethyl-3-methyl-imidazolium chloride (EMImCl) (marketed by the Solvionic® company), previously dried for 12 hours at 120° C. under reduced pressure by means of a rotary vane pump, and dry aluminium chloride of 99.99% purity (marketed by the Sigma Aldrich® company) are fed into a glovebox (experimental container). The nitrogen-containing derivative EMImCl is fed into a dry glass vessel under stirring and aluminium trichloride AlCl₃ is progressively added while limiting exothermy and maintaining a molar ratio R of 1.5 (ranging between 1.01 and 2).

The corrosion is measured in the glovebox using a potentiostat SP 150 marketed by the BioLogic® company, and the data is displayed and processed using the EC-Lab® software. A three-electrode setup was used with a 1-mm diameter aluminium wire (marketed by the Goodfellow® company with a 99.9999% purity) as the working electrode, a 4-mm diameter tungsten counter-electrode and a reference (or quasi-reference) electrode consisting of an aluminium wire (1-mm diameter, of 99.9999% purity, marketed by the Goodfellow® company) immersed in a mixture of same composition as the medium to be studied and separated from the solution by a porous sintered material.

Electrochemical linear polarization measurement is performed with a scan rate of ±50 mV at 1 mV·s⁻¹ relative to the rest potential measured at 0.082 V. The Tafel curves, which log current versus voltage curves, are then drawn. These curves include a cathode line (oxygen or proton reduction reaction) and an anode line (metal oxidation) on either side of the corrosion potential. The corrosion current is then deduced from the coordinates of the point of intersection of these two lines. The course of the Tafel curves allows to determine for this experimentation a corrosion current density below 3 μA·cm⁻². This value is extremely low and shows that the electrolyte causes particularly little corrosion to aluminium under the conditions of the experiment.

### Example 2

In order to establish the electrical characteristics of the cell according to the invention, the applicant has carried out experimental measurements. FIG. 1 shows the setup of the cell used for measurements. Using a glovebox, we assemble, on a metal support (5) provided with an insulating coating and with a venting device (8), the body of cell (4) made of PTFE and equipped, on either side, with seals and an opening (7) allowing the electrolyte to be injected between an aluminium plate (2) and an air electrode (1). A clamping lever (6) provides sealing of the assembly.

The electrochemical cell is made up of an E-4 air electrode (1) marketed by the Electric Fuel® company, an aluminium plate (2) of dimensions 25×25 mm×2 mm, of 99.999% purity, marketed by the Goodfellow® company, and of the AlCl3/EMImCl mixture (with a molar ratio R=1.5) as electrolyte (3). The distance between aluminium plate (2) and air electrode (1) is 10 mm for a cell body inside diameter of 15 mm.

The complete setup containing electrolyte (3) is placed in a glass cell comprising two sealed outlet ports allowing electrical connection to a potentiostat, an inlet for dry air freed of carbon dioxide using a molecular sieve. The rate of air inflow into the cell is set at 30 ml/min.

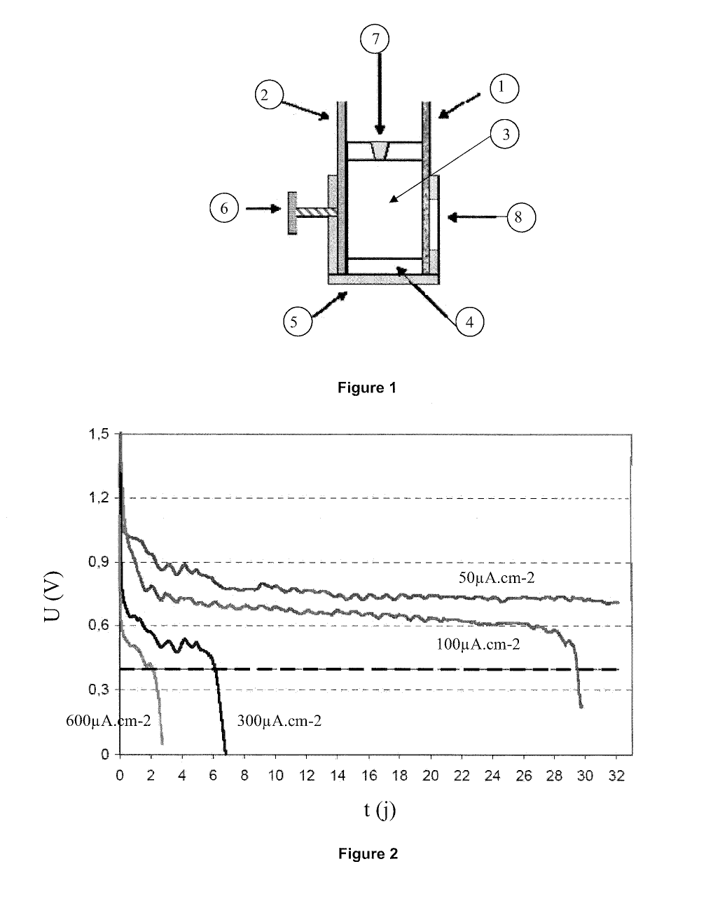

The galvanoplastic discharge manipulations were performed using an SP 150 potentiostat marketed by the BioLogic® company, the data was displayed and processed by means of the EC-Lab® software. The discharge measurements were performed for different current densities: −50 μA·cm⁻²; −100 μA·cm⁻²; −300 μA·cm⁻²; and −600 A·cm⁻² at a temperature of 22° C.±3° C. The discharge curves obtained are shown in FIG. 2. These curves represent the evolution of voltage U (in V) at the cell terminals as a function of time t (in days).

Table 1 shows the results obtained after calculation.

TABLE 1

| | Discharge | Discharge | | Battery |
|---|---|---|---|---|
| | voltage | time | Capacity | energy |
| | V | h | Ah | Wh |
| −100 μA · cm⁻² | 0.67 | 713 | 0.125 | 0.084 |
| −300 μA · cm⁻² | 0.55 | 161 | 0.085 | 0.047 |
| −600 μA · cm⁻² | 0.45 | 47 | 0.050 | 0.023 |

The results obtained show that, in a non-corrosive aprotic medium, the aluminium-air electrochemical system allows energy generation from aluminium and the oxygen in air.

Comparative examples with different metal-air systems are available in the literature and show that the system described is interesting, as indicated by the comparative values of Table 2.

TABLE 2

| | | Voltage | Capacity/carbon |
|---|---|---|---|
| Electrode | Electrolyte | (V) | (mAh/g) |
| Lithium | LiClO₄ EC/PC | 2.8 | 2220 |
| Silicon | EMlm(FH)_{2, 3} F | 0.95 | 2255 |
| Aluminium | AlCl₃/EMlmCl (with R = 1.5) | 0.67 | 5250 |

It can be noted that the values in the table are determined for a current density of −100 μA·cm⁻². The first example (lithium electrode) is shown notably in the document: Takashi Kuboki, Tetsuo Okuyama, Takahisa Ohsaki, Norio Takami, “Lithium-air batteries using hydrophobic room temperature ionic liquid electrolyte”, Journal of Power Sources 146, 766-769 (2005). Concerning the second example (silicon electrode), the values are calculated using data from the following document: Gil Cohn, Yair Ein-Eli, “Study and development of non-aqueous silicon-air battery”, Journal of Power Sources 195, 4963-4970 (2010).

The capacity/carbon value is calculated by taking into account the mass of carbon and of the air electrode catalyst, this capacity therefore corresponds to the capacity of the cell per unit of mass. It can be noted that the cell according to the invention allows to build a cell with a higher capacity/carbon value than the lithium-air or silicon-air cells described in the literature.

### Example 3

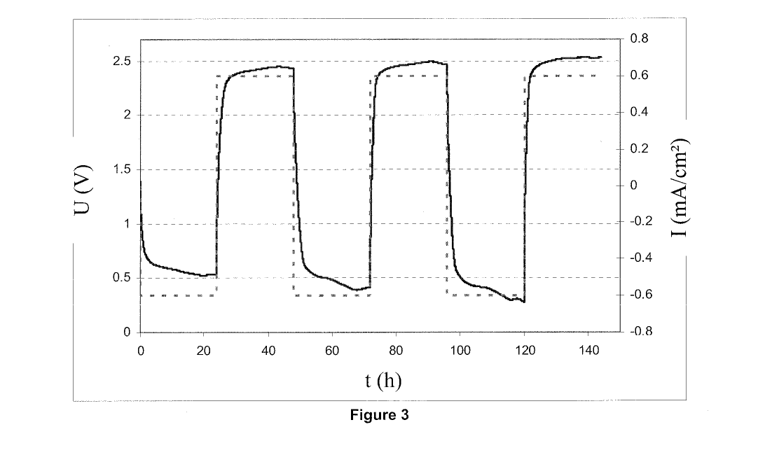

A cell identical to the cell of Example 2 is built. This cell is subjected to several charge/discharge cycles by imposing a current on the cell. FIG. 3 illustrates the behaviour of the cell for these charge/discharge cycles. The curve in full line corresponds to the voltage U at the cell terminals. The curve in dotted line corresponds to the current I imposed on the cell. These curves show the evolution of voltage U (in V) and of current I (in mA/cm²) at the cell terminals as a function of time (in hours).

To simulate the charge/discharge cycles, a positive (+0.6 mA/cm²) and a negative (−0.6 mA/cm²) direct current is imposed for charge and discharge respectively.

It can be noted that the voltage substantially ranges from 0.5 to 2.5 V, and that the voltage curve follows the charge and discharge curve. Therefore, the cell according to the invention is suited for a rechargeable accumulator (battery).

1) An electrochemical cell capable of generating and/or accumulating electrical energy, comprising an oxidizable electrode made of aluminium or aluminium alloy, a conductive air electrode allowing the diffusion of air and reduction of the oxygen in air, and an electrolyte, characterized in that said electrolyte is non-aqueous and comprises a mixture of aluminium trichloride (AlCl₃) with a chlorinated cyclic or heterocyclic, aliphatic nitrogen derivative.

2) A cell as claimed in claim 1 wherein, within electrolyte, the molar ratio of the proportion of aluminium trichloride (AlCl₃) to the proportion of chlorinated cyclic or heterocyclic, aliphatic nitrogen derivative ranges between 1.01 and 2.

3) A cell as claimed in claim 1, wherein the chlorinated cyclic or heterocyclic, aliphatic nitrogen derivative of electrolyte is selected from among 1-ethyl-3-methyl-imidazolium chloride (EMImCl), 1-butyl-3-methyl-imidazolium chloride, 1-butyl-pyridinium chloride or benzyltrimethylammonium chloride.

4) A cell as claimed in claim 3, wherein the molar ratio of the proportion of aluminium trichloride to the proportion of 1-ethyl-3-methyl-imidazolium chloride (EMImCl) is substantially equal to 1.5.

5) A cell as claimed in claim 1, wherein said electrolyte also comprises an organic liquid and/or an ionic liquid.

6) A cell as claimed in claim 1, wherein said electrolyte is liquid at the ambient operating temperature of the cell.

7) A cell as claimed in claim 5, wherein said electrolyte is a gel at the ambient operating temperature of said cell.

8) A cell as claimed in claim 1, wherein said air electrode comprises a microporous multilayer assembly and an active element allowing oxygen reduction.

9) A cell as claimed in claim 8, wherein said air electrode consists of porous carbon, of an oxygen reduction catalyst, of a perfluorinated polymer and of a current collector.

10) A cell as claimed in claim 9, wherein said oxygen reduction catalyst is selected from among the metal oxides, notably manganese, nickel or cobalt oxides, or among the doped metal oxides, or among the noble metals.

11) A cell as claimed in claim 9, wherein said cell also comprises porous devices upstream from the air electrode.

12) An electrochemical system for storing electrical energy, characterized in that it consists of at least one cell as claimed in claim 1.

13) An electrochemical system for storing electrical energy, characterized in that it comprises a plurality of cells as claimed in claim 1, arranged in series and/or in parallel.

14) A vehicle, notably a motor vehicle, comprising at least one electric machine, characterized in that the vehicle is equipped with an electrical energy storage system as claimed in claim 13 for supplying said electric machine.
